(19) United States
(12) Patent Application Publication
(10) Pub. No.: US 2004/0203906 A1
(43) Pub. Date: Oct. 14, 2004

(54) Monitoring device and monitoring system for monitoring the location of communication devices

(76) Inventors: Takayuki Kato, Senadai (JP); Hiroko Takahashi, Natori (JP); Kyoko Tanaka, Senadai (JP); Tomohiro Sasaki, Senadai (JP); Tomoki Iwabuchi, Senadai (JP)

Correspondence Address: KATTEN MUCHIN ZAVIS ROSENMAN, 575 MADISON AVENUE, NEW YORK, NY, 10022-2585, US

(21) Appl. No.: 10/331,283

(22) Filed: Dec. 30, 2002

(30) Foreign Application Priority Data
Apr. 19, 2002 (JP) 2002-116907

(51) Int. Cl. H04Q 7/20

(52) U.S. Cl. 455/456.1; 455/404.1

(57) ABSTRACT

The purpose of this invention is to provide a monitoring system that displays the place in which a communication device to be monitored by a monitoring device is installed, on a plane or in three dimensions in a suitable position on a map displayed on a terminal screen on the monitoring device side. The location monitoring system is composed in such a way that it has communication devices and a monitoring device that monitors the communication devices. The communication device acquires current location information, generates network control messages (for example, SNMP messages) that include the acquired location information, and transmits the generated network control messages to the monitoring device. The monitoring device extracts the location information from the received network control messages, maps the location information of the communication devices onto map information and displays it on a terminal screen.

### BACKGROUND OF THE INVENTION

1. Field of the Invention

This invention concerns a communication device on a communication network and a monitoring device and monitoring system that monitor communication devices; in particular, it concerns a communication device that transfers packets on a TCP and/or IP (TCP/IP) network, and a monitoring device and monitoring system that monitor these communication devices.

2. Description of Related Art

In a conventional network monitoring system, in order to ascertain the physical installation location of each communication device (for example, router, transmitter, relay, etc.) connected to the network, its physical installation location is measured by a manual operation by GPS (the Global Positioning System), etc. when the communication device is installed, and the measurement data is present as installation location information in the communication device. There is a method in which, if installing a new device to be monitored as a constituent element of the network based on its installation location information, GPS is used to acquire and manually set the installation location information of this device to be monitored (unexamined patent 2000-13471).

Technology has been disclosed in which the location information is transmitted from the communication device to the network monitoring system. In the network monitoring system a correspondence is made between physical installation information and the identifier of the communication device, and the installation location of the communication device is specified based on the identifier transmitted from the communication device.

But communication devices deployed in a network are often reinstalled in different locations when for example an office is moved. In such cases, with the conventional method for setting such installation location information, if a communication device is reinstalled in a different location, it is necessary to again reset the installation location information manually.

But because this is done by humans, the location information might be set mistaken, or someone might forget to set the location information, which creates the problem that the location information that is set might not agree with the installation location of the communication device that is actually installed.

And every time a communication device is reinstalled, there is also the problem of having to go to the trouble of setting the location information in the communication device.

If two or more communication devices are installed on different floors of the same building, they might be set in the same location on a map, which gives rise to the problem of not being able to distinguish which level (floor) each is installed on.

### SUMMARY OF THE INVENTION

From the foregoing, the purpose is to provide a monitoring system that displays the place in which a communication device to be monitored by a monitoring device is installed, on a plane or in three dimensions in a suitable position on a map displayed on a terminal screen on the monitoring device side.

Another purpose is to provide a communication device that automatically acquires on its own the location where the communication device is installed and notifies the monitoring device of the location information it has acquired.

Still another purpose is to provide a communication device that automatically acquires, on its own, altitude information at the location where the communication device is installed and notifies the monitoring device of the location information it has acquired, including the altitude information.

The present invention includes the following composition:

The location monitoring system includes communication devices and a monitoring device that monitors the communication devices. A communication device acquires current location information, generates network control messages (for example, SNMP messages) including the acquired location information, and transmits the generated network control messages to the monitoring device. The monitoring device extracts the location information from the received network control messages and maps the location information of the communication devices onto map information and displays it on a terminal screen.

In another embodiment, a location monitoring system includes communication devices and a monitoring device that monitors the communication devices. A communication device has a acquires the latitude, longitude, and altitude as current location information, generates network control messages including the acquired current location information, and transmits the generated network control messages to the monitoring device. The monitoring device extracts the location information from the received network control messages and maps the location information of the communication devices onto map information and displays it on a terminal screen, and also displays information concerning the altitude.

In another embodiment, a communication device in a location monitoring system is characterized in that—in a communication device of a location monitoring system that includes communication devices and a monitoring device that monitors the communication devices, and has an extracting unit that extracts location information from network control messages received from the communication devices, and maps it onto the map information based on the location information and displays it on a terminal screen. A communication device has a unit that acquires current location information, a unit that generates network control messages including the acquired current location information, and a unit that transmits the generated network control messages to a network manager (for example, SNMP manager).

Another embodiment of the monitoring device of a monitoring system is characterized in that—in a monitoring device of a monitoring system that has communication devices and a monitoring device that monitors the communication devices, and a communication device has a unit that acquires the latitude, longitude, and altitude as current location information, and a unit that generates network control messages including the acquired current location information, and a unit that transmits the generated network control messages to the monitoring device. The monitoring device has a unit that extracts the location information from received network control messages, and a unit that maps the location information of the communication devices onto map information and displays it on a terminal screen, and also displays information concerning the altitude.

In another embodiment a communication device installation location display method where a monitoring device of a monitoring system that has communication devices and a monitoring device that monitors the communication devices includes a step that acquires current location information, a step that generates network control messages including acquired location information, a step that transmits generated network control messages to the monitoring device, a step that extracts the location information from received network control messages, and a step that maps the location information of the communication devices onto map information and displays it on a terminal screen.

The above-described embodiments of this invention may be combined in various combinations and configurations.

### BRIEF EXPLANATION OF THE DRAWINGS

FIG. 1 is a diagram showing a configuration applied to a network that includes multiple communication devices and a monitoring device that monitors the communication devices;

FIG. 2 is a diagram showing a local network frame format of an SNMP message;

FIG. 3 is a diagram showing the PDU format of an SNMP message relating;

FIG. 4 is a diagram showing an embodiment applied to a network that includes multiple communication devices and a monitoring device that monitors the communication devices;

FIG. 5 is a diagram showing the procedure of this invention by which an SNMP message acquires location information from an SNMP agent;

FIG. 6 is a diagram showing the map refresh procedure of this invention based on a location information request to a communication terminal and the acquired location information when a map refresh request is made from the console of the monitoring device;

FIG. 7 is a diagram showing the procedure of this invention by which, if an event is detected in a communication device, an SNMP message that includes the location information is transmitted to the monitoring device;

FIG. 8 is a diagram showing the procedure of this invention by which, when the SNMP manager receives a trap message from a communication device, fault information is displayed on a map based on location information included in the message;

FIG. 9 is a diagram showing the flow of control from when a refresh request is received from the operator of the monitoring device until the display is made on the terminal;

FIG. 10 is a diagram showing the flow of control until the SNMP manager receives a trap message that includes the restart request event and the location information when there has been a restart request at a communication device, and the event and the location information of the communication terminal are displayed on the terminal; and

FIG. 11 is a diagram showing an example in which, if multiple communication devices are installed inside the same building, the state of installation of each communication device is displayed based on location information from the communication devices.

### DETAILED DESCRIPITION

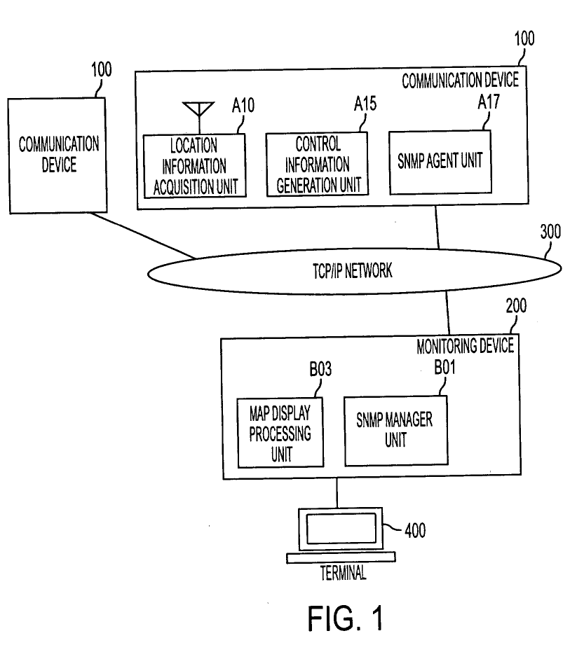

FIG. 1 shows an example of the configuration of a network to which this invention is applied that includes multiple communication devices and a monitoring device that monitors the communication devices. In the diagram, in the communication devices it is also possible to connect to monitoring device 200 conventional communication devices that are not equipped with a location information acquisition unit, but they cannot receive the service offered by this invention.

An example of the composition of this invention using the reference symbols of FIG. 1 is described.

Reference symbol 100 denotes a communication device. A10 is its location information acquisition unit. A15 is a control information generation unit; it generates MIB information. A17 is an SNMP agent unit; it is equipped with, for example, a router or other communication device.

200 is a monitoring device that monitors the communication devices. This monitoring device may monitor not just communication devices 100 but also the network composition, faults, and performance of TCP/IP network 300. B01 is an SNMP manager; it passes information with one or more SNMP agents A17 and effects network composition, performance monitoring, and fault control, etc.

In this specification, the system configuration through coordination of the SNMP manager and SNMP agents is referred to as the network monitoring system. B03 is a map display processing unit; it displays, superimposed on map information displayed on the screen of terminal 400, in positions on the screen indicated by the location information transmitted from communication device 100, symbols, etc. whose meaning is indicated by the SNMP message information. There may be multiple symbols, and they may be symbols that express multiple meanings.

As above, monitoring device 200 receives SNMP messages concerning configuration information, fault information, performance information, etc. detected by the communication devices and TCP/IP network 300, displays on terminal 400 a suitable map based on the location information included in these messages, and displays symbols of said SNMP message information in places on the map indicated by the location information. For example, a symbol indicating the meaning that a communication device has failed might display, for example, an X mark.

1. Principle of Operation of this Invention.

The principle of operation of this invention are explained with reference to FIG. 1. In the drawings, the same reference symbols indicate the same or equal objects.

First, as examples of devices for communication device 100 to which to apply this invention, a listmay include routers, optical wavelength multiplex transmitters, wireless relays, wireless LAN devices, optical wavelength switches, and optical cross-connects. Also, location information acquisition unit A10 of this communication device 100 receives electromagnetic waves transmitted from, for example, wireless ground stations or GPS satellites using a GPS device, etc., and acquires the location information of this communication device.

And based on a location information request from control information generation unit A15, location information acquisition unit A10 responds to the request origin with the location information. The location information may also be acquired periodically or nonperiodically due to such reasons as, in order to reduce the power consumption of location information acquisition unit A10.

In acquiring this location information, a portable terminal (for example, a mobile telephone) that is equipped with the function of detecting location information may be used. If communication device 100 is installed in a place that is out of radio range, it becomes difficult to acquire location information from GPS satellites or wireless ground stations, etc.

In such a case, an antenna may be installed in a location that can be reached by electromagnetic waves and transmit to the GPS device or portable terminal using a transmission cable or wireless device, etc. A location information acquisition unit A10 may be installed in a place where GPS radio waves, etc. can be received and transmit from there to communication device 100 using a transmission cable or radio device, etc.

Control information generation unit A15 may hold the location information received from location information acquisition unit A10. For holding this location information, one may use, for example, a static random access memory (SRAM), which can hold memory by batteries, etc., even if the power source is cut off. If such a SRAM or other memory holding element is used, then if the GPS device or other location information acquisition unit A10 fails, the location information held by control information generation unit A15 may be used.

Control information generation unit A15 generates MIB information. This “MIB (Management Information Base) information” means a database that the SNMP manager controls by assigning identifiers (numbers) in a tree structure so that the information by which it keeps track of the communication devices can be efficiently looked up and updated. Control information generation unit A15 generates the MIB information to be transmitted to SNMP manager unit B01 of monitoring device 200.

Also, location information also may be generated together as MIB information. And at this time MIB information may be generated that is only location information. Moreover, if the specifications are that the linked SNMP manager does not handle the location information, then it may also be arranged that control information generation unit A15 does not generate location information.

That is, whether to transmit location information to the SNMP manager can be set by a setting function (or installation, etc.) of communication device 100. Also, it may be arranged that, based on a preset message from the SNMP manager, control information generation unit A15 does not generate location information.

SNMP manager unit B01 of monitoring device 200 receives SNMP messages from communication device 100. SNMP manager unit B01 in turn passes this SNMP message to map display processing unit B03. And map display processing unit B03 analyzes the SNMP message and displays on the screen of terminal 400 a symbol, etc. that abstractly expresses its meaning.

For example, upon receiving from a communication device an SNMP message saying that a fault has occurred, a display in red is made. The location information of the communication device and map information relating to the location information are read from the map database, the map information (including the name of the building and such three-dimensional information as the height of the building and its elevation above sea level) is displayed on the screen of terminal 400, and the location information of the communication device is mapped onto the map information.

A symbol, etc. indicating the meaning of the SNMP message may also be displayed. Its display makes it easy to visually tell, for example, the installation location of a communication device that generates a fault.

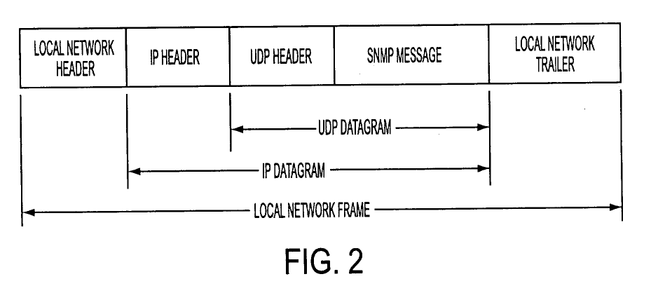

With reference to FIGS. 2-4, the data format of the packets (frames) that are exchanged between the SNMP agent and the SNMP manager on TCP/IP network 300 are described.

FIG. 2 shows the local network frame of an SNMP message. First, the beginning (left side) of the local network header is the header of layer 2, and a MAC (Media Access Control) header is used.

And because an SNMP message normally is transferred by UDP (User Datagram Protocol), an IP header and UDP header are added. Then the SNMP message follows, and finally a local network trailer is added.

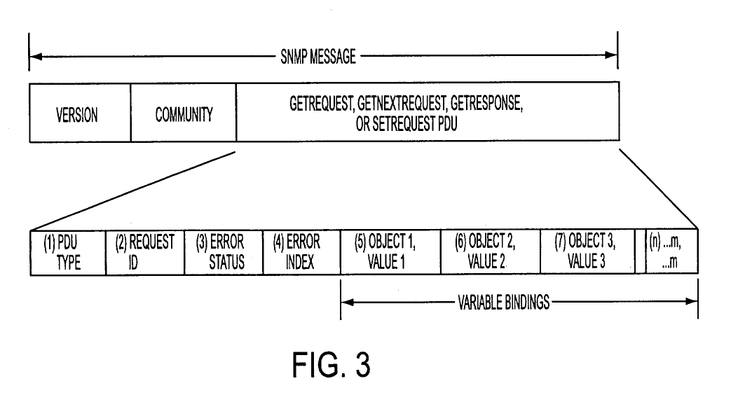

FIG. 3 shows an example of an SNMP message format in FIG. 2.

In the diagram, Version indicates the SNMP version. Version includes 1, 2, and 3. Community is used as an authentication password for the SNMP message. In other words, SNMP message exchange can be done only for those that have the same Community value between the SNMP agent and the SNMP manager.

In the following we describe fields (1)-(7) of FIG. 3.

(1) The PDU types are (a) GetRequest PDU, (b) GetNextRequest PDU, (c) GetResponse PDU, (d) SetRequest PDU, and (e) Trap PDU.

(2) The Request ID assigns a unique identification (ID) to each request and distinguishes multiple unresponded-to requests.

(3) Error Status indicates that there was an abnormality at the time of processing of the request. This value could be 0: NoError, 1: tooBig, 2: noSuchName, 3: badValue, 4: readOnly, or 5: genErr.

(4) Error Index, if the Error Status is not 0 (NoError), indicates which variable caused the error during while the error index was in the midst of variable binding.

(5)-(n) Object (1-m) and Value (1-m) indicate an array of 1-m units of variable name (1-m) (the relationship between n and m is such that m=n−4).

### 2. FIRST EMBODIMENT

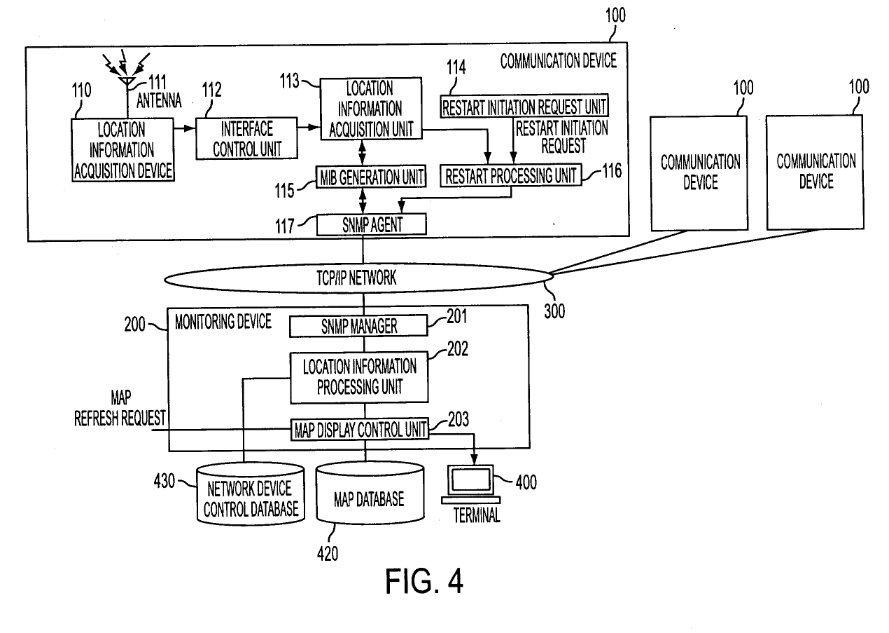

FIG. 4 shows the configuration of a network that has communication devices and a monitoring device that monitors the communication devices, of the first embodiment of this invention.

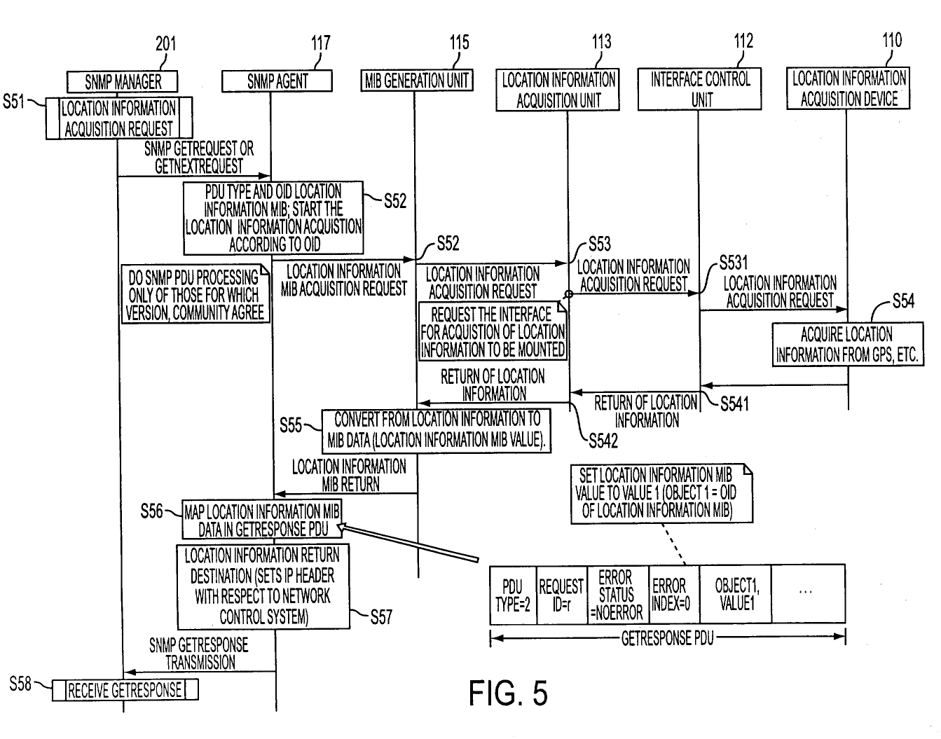

FIG. 4 and FIG. 5 show, an example of an embodiment in which the monitoring device makes acquisition requests to communication devices for installation location information of the communication devices themselves, and acquires the location information.

SNMP manager 201 (FIG. 4, FIG. 5) of FIG. 5 corresponds to SNMP manager unit B01 in FIG. 1; in step S51 (FIG. 5). SNMP manager unit B01 transmits to SNMP agent 117 (which corresponds to SNMP agent unit A17) of communication device 100 an SNMP message having PDU type GetRequest or GetNextRecord (transmission of location information acquisition request).

In step S52, SNMP agent 117 receives an SNMP message (including location information acquisition request) via TCP/IP network 300. Then, after confirming the correctness of the Version and Community of this message, it concludes that the PDU type is, for example GetRequest or GetNextRecord and takes Object 1 to be an acquisition request for location information and Object 2 to be a sysLocation. In this example, it does not matter whether sysLocation Object 2 is omitted, but it is taken as having been specified.

SNMP agent 117 makes an MIB acquisition request for location information and the sysLocation to MIB generation unit 115 (which corresponds to control information generation unit A15).

Based on the received MIB acquisition request for location information, MIB generation unit 115 makes an acquisition request for location information to location information acquisition unit 113 (which corresponds to location information acquisition unit A10).

In step S53, location information acquisition unit 113 makes a request for acquisition of location information to interface control unit 112 (which corresponds to location information acquisition unit A10). In addition, interface control unit 112 makes a request for acquisition of location information to location information acquisition device 110 (which corresponds to location information acquisition unit A10).

In step S54, based on the acquisition request, location information acquisition device 110 responds to interface control unit 112 with location information held by location information acquisition device 110. For the interface between location information acquisition device 110 and interface control unit 112, the connection may be made by any of RSC232C, USB, PCMCIA, etc. Also, location information acquisition device 110 may acquire location information from a GPS device or a portable terminal that has the function of acquiring location information, and hold this location information.

In step S55, MIB generation unit 115 acquires through interface control unit 112 and location information acquisition unit 113 the location information that location information acquisition device 110 responds with. Based on this location information, it generates MIB information that includes the location information and sysLocation information. This sysLocation is taken to be what results when MIB generation unit 115 generates information concerning the installation location.

For example, it is assumed that it generates MIB information such as “a router is installed near the third window from the left on the north side on the third floor of the ABC Building” or “Installed in the security room in basement 1 of the XYZ Building. To get the key to the security room, one must contact the superintendent and obtain it beforehand.” The MIB generation unit 115 passes an SNMP message including the generated MIB information to SNMP agent 117.

In step S56, an example is listed (in the lower right of FIG. 5) in which SNMP agent 117 is mapped, setting the location information transmitted from MIB generation unit 115 in GetResponse PDU as object 1. Also, the sysLocation information is mapped as Object 2 in the following part “. . . ”. By this PDU format, it is clear that location information is set in Object 1. Also, although not pictured, it is taken that the aforesaid sysLocation information is generated in Object 2.

In step S57, the IP and UDP header, etc. are generated that are necessary for transmitting to SNMP manager 201 the GetResponse PDU generated by SNMP agent 117 in step S56. A packet including the generated GetResponse PDU is transmitted to SNMP manager 201.

In step S58, SNMP manager 201 receives the aforesaid SNMP message packet (GetResponse PDU) that includes the GetResponse PDU.

As above, SNMP manager 201 can receive this communication device location information that is included in the SNMP message that is transmitted from a communication device. Also, if a sysLocation acquisition request is made, supplementary information relating to more detailed information can also be acquired.

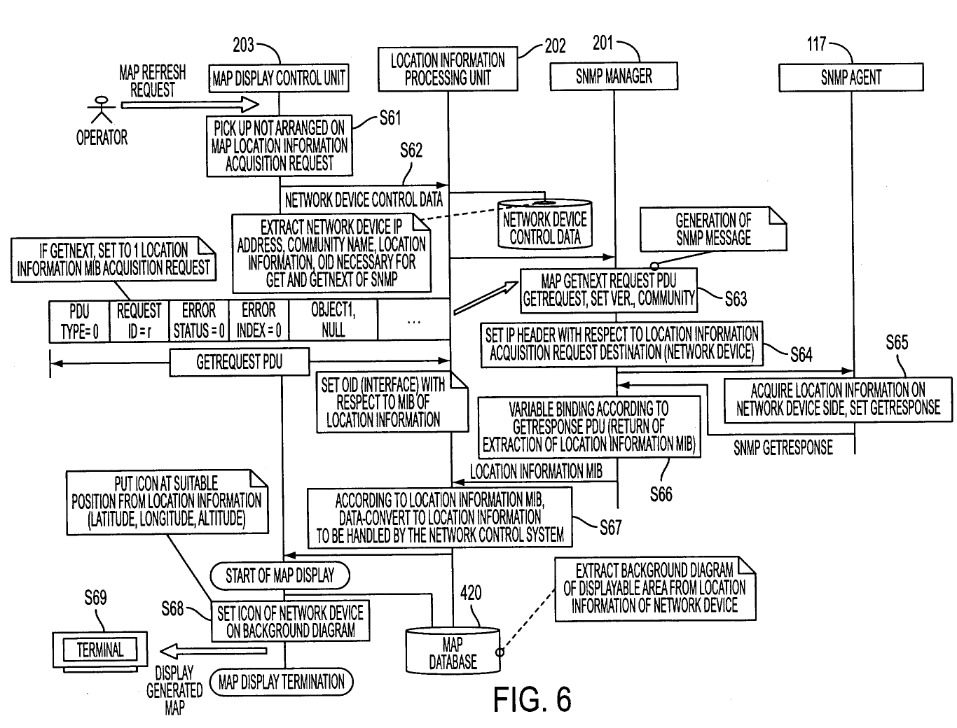

FIG. 6 shows the processing flow in the case in which the operator of monitoring device 200 requests a map refresh request from the console device (not pictured) or terminal device 400, etc.

This shows an example of an embodiment in which, if monitoring device 200 receives a map refresh request from the console device or terminal device 400, etc., it displays to a communication device (node device) or all communication devices (all communication nodes) displayed on its screen, on terminal device 400, a map generated based on the location information.

In step S61, map display control unit 203 (which corresponds to map display processing unit A03) selects a communication device (node device) on the map based on this map refresh request. Then it calls upon location information processing unit 202 (which corresponds to map display processing unit A03) for an acquisition request for location information to the selected communication device.

In step S62, location information processing unit 202 accesses network device control data 430 and obtains the transmission destination/transmission origin IP address, Community, and other information needed for passing a GetRequest or GetNextRequest PDU to the SNMP manager with respect to one or more selected communication devices. Then it calls upon SNMP manager 201 for a MIB acquisition request for location information together with this information.

In steps S63-S64, SNMP manager 201 receives from location information processing unit 202 the location information MIB acquisition request and relevant information. Based on the relevant information (Version, Community, transmission destination IP/transmission origin address, GetRequest/GetNextRequest message) that location information processing unit 202 obtains from network device control data 430, SNMP manager 201 generates an SNMP message, and transmits this SNMP message packet to the communication devices selected in step S62.

In step S65, SNMP agent 117 receives the SNMP message packet from SNMP manager 201. Then, on the communication device 100 side, it acquires location information as described in steps S51-S58 of FIG. 5 and sends back this acquired location information to SNMP manager 201 as an SNMP message packet (GetResponse, etc.).

In step S66, SNMP manager 201 receives the SNMP message packet sent back from the communication device 100 side and extracts the location information (location information MIB) from the message (GetResponse, etc.). Then it reports the location information MIB to location information processing unit 202.

In step S67, the MIB information of the location information that location information processing unit 202 received from SNMP manager 201 is converted to the data format for monitoring device (network control system) 200. At this time, network device control database 430 may be updated/stored into based on information concerning the communication device, for example, position information (longitude, latitude, altitude), node name, IP address, etc. Then the converted location information is passed to map display control unit 203.

In steps S68-S69, based on the converted location information received from location information processing unit 202, a map of a suitable scale and of a range that can be displayed on the screen is read from map database 420 (FIG. 4). Then this map is displayed as the background map on the terminal screen. Meanwhile, the display position on the background map displayed on the terminal is specified based on the converted location information. Then the location of communication device 100 is redisplayed on the screen. Then the map refresh display processing is ended.

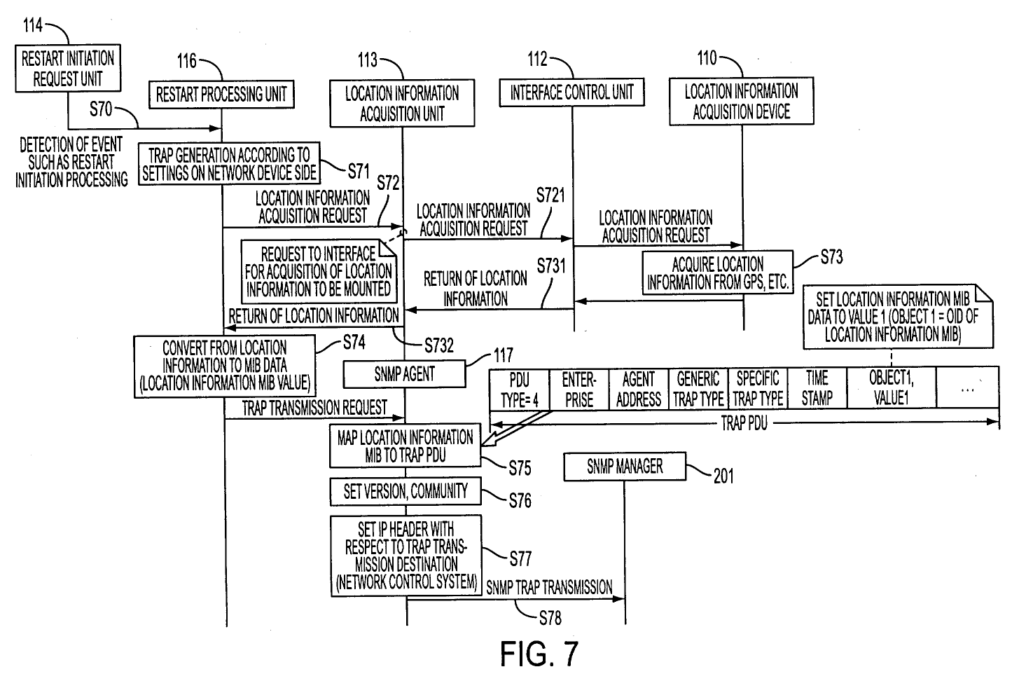

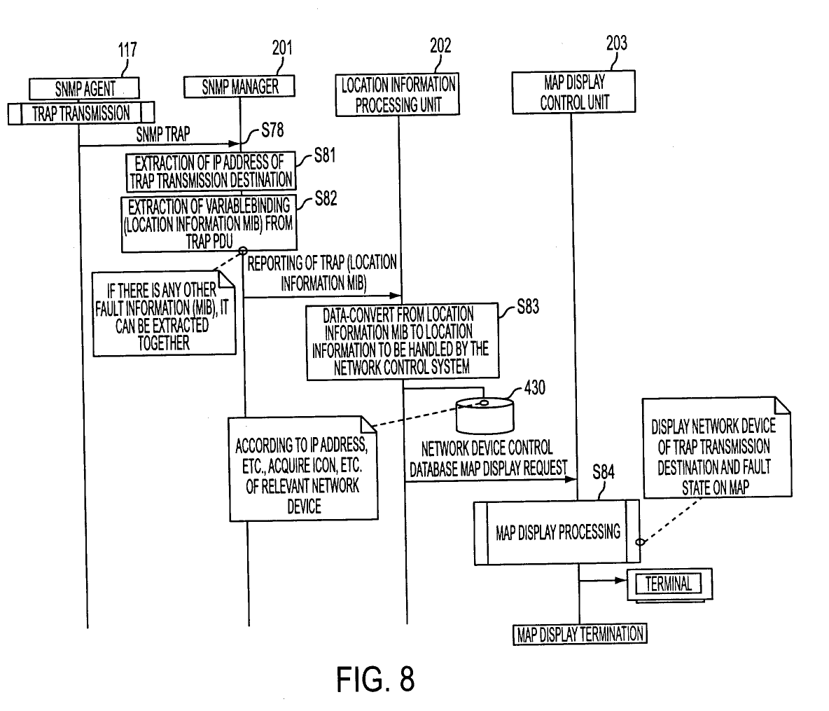

FIG. 7 and FIG. 8 show an example of the processing for an event such as restart initiation processing is detected in a communication device.

In step S70, an event such as restart initiation processing is detected in restart initiation request unit 114 of communication device 100. Restart initiation request unit 114, upon detection of this event, makes a restart initiation request to restart processing unit 116.

In steps S71 and S72, restart processing unit 116 receives the restart initiation request from restart initiation request unit 114, generates a trap message according to the setting of communication device 100, and makes an acquisition request for location information to location information acquisition device 110 via location information acquisition unit 113 and interface control unit 112.

In step S73, the acquisition request for location information is received, and location information of the communication device itself is acquired from a GPS device, etc., as already described. Then restart processing unit 116 receives, via interface control unit 112 and location information acquisition unit 113, the location information acquired by location information acquisition device 110.

In step S74, the location information received by restart processing unit 116 is converted to MIB information. Then a request is made to transmit the trap message to the SNMP agent.

In step S75, a transmission request for the trap message is made to SNMP agent 117, taking as parameters the trap message generated in step S71 and the location information MIB.

In step S76, SNMP agent 117 maps the MIB information and location information MIB that are the cause of the restart request to a trap PDU.

In step S77, SNMP agent 117 adds the Community, Version, IP header, and UDP header to the trap PDU and transmits a trap message packet to SNMP manager 201.

In step S78, SNMP manager 201 receives the SNMP trap packet. The procedure from here forward is described with reference to FIG. 8.

In steps S81-S82, the transmission origin IP address (on the SNMP agent side) of the trap packet received by SNMP manager 201 is extracted. Then the fault information MIB that was the cause of the restart request and the location information MIB are taken out from the trap PDU. SNMP manager 201 reports the taken-out location information to location information processing unit 202.

In step S83, location information processing unit 202 converts the location information MIB reported from SNMP manager 201 into a data format that is easy to data-process. At this time, network device control database 430 may be updated/stored into based on information concerning the communication device, for example, position information (longitude, latitude, altitude), node name, IP address, etc.

Next, based on the transmission origin IP address, the terminal display icon, etc. of the relevant communication device (network device) is acquired from network device control database 430. Next a map display request is requested of the map display control unit.

In step S84, map display control unit 203 performs map display processing based on the map display request from location information processing unit 202. Specifically, based on the location information received from location information processing unit 202, it reads from map database 420 (FIG. 4) a map of a suitable scale and of a range that can be displayed on the screen.

Then this map is displayed as the background map on the terminal screen. Meanwhile, the display position on the background map displayed on the terminal is specified based on the converted location information. Then an icon, etc. corresponding to the communication device is displayed on the terminal screen in a position that corresponds to the converted location information, and the display processing is ended.

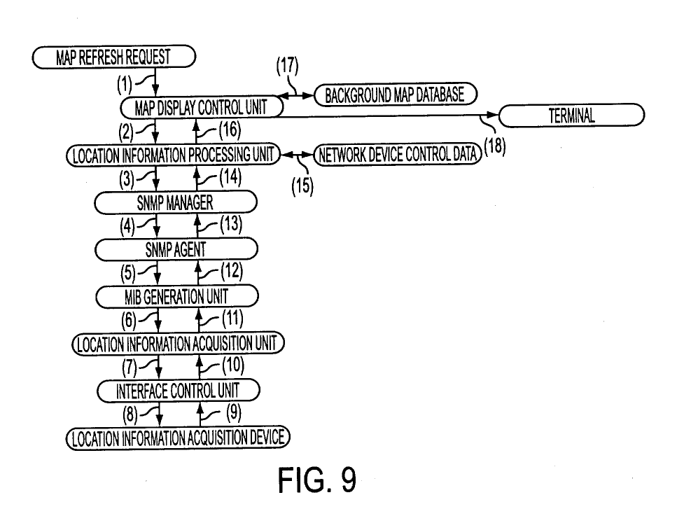

FIG. 9 shows an example of the processing sequence when a map refresh request is received from the operator. The correspondence with the passages in this specification is described as follows, referring to reference symbols (1)-(18) in FIG. 9 and to FIG. 6.

(1)-(2): FIG. 6, step S61

(2)-(3): Step S62 (FIG. 6)

(3)-(4): Step S63 (FIG. 6)

(4)-(5): Step 65 (including step S52) (FIG. 6)

(5)-(6): Step S521 (FIG. 5)

(6)-(7): Step S53 (FIG. 5)

(7)-(8): Step S531 (FIG. 5)

(8)-(9): Step S54 (FIG. 5)

(9)-(10): Step S541 (FIG. 5)

(10)-(11): Step S542 (FIG. 5)

(11)-(12): Step S55 (FIG. 5)

(12)-(13): Steps S56-S57 (FIG. 5)

(13)-(14): Step S58 (FIG. 5)

(14)-(15): Step S67 (FIG. 6)

(15)-(18): Steps S68-S69 (FIG. 6)

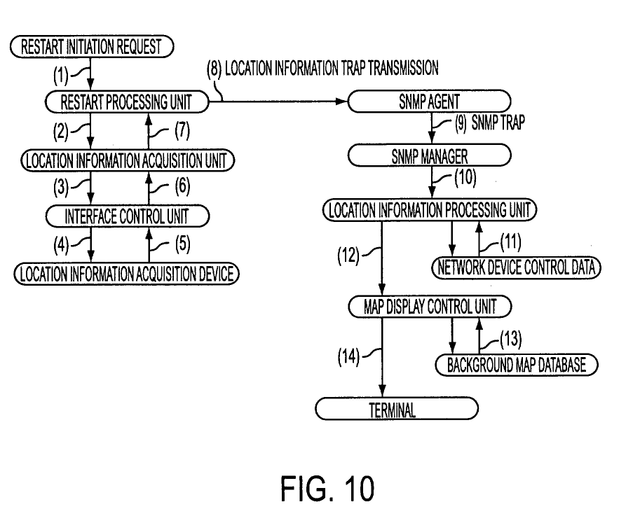

FIG. 10 shows an example of the processing sequence when a communication device detects a fault or other abnormality and receives a restart initiation request. The correspondence with the passages in this specification is described as follows according to the reference symbols in FIG. 10, referring to reference symbols (1)-(14) in FIG. 10 and to FIG. 7.

(1)-(2): Step S71 (FIG. 7)

(2)-(3): Step S72 (FIG. 7)

(3)-(4): Step S721 (FIG. 7)

(5)-(6): Step S73 (FIG. 7)

(6)-(7): Step S731 (FIG. 7)

(8)-(9): Step S732 (FIG. 7)

(10)-(11): Step S74 (FIG. 7)

(12)-(13): Steps S75-S77 (FIG. 7)

(14)-(15): Step S78 (FIG. 7)

### SECOND EMBODIMENT

A feature of the first embodiment is that latitude and longitude are used as location information. That is, the monitoring device receives location information transmitted from a communication device, maps this location information and map information, and visually displays on the terminal screen the position in which the communication device is installed on the map displayed on the terminal screen.

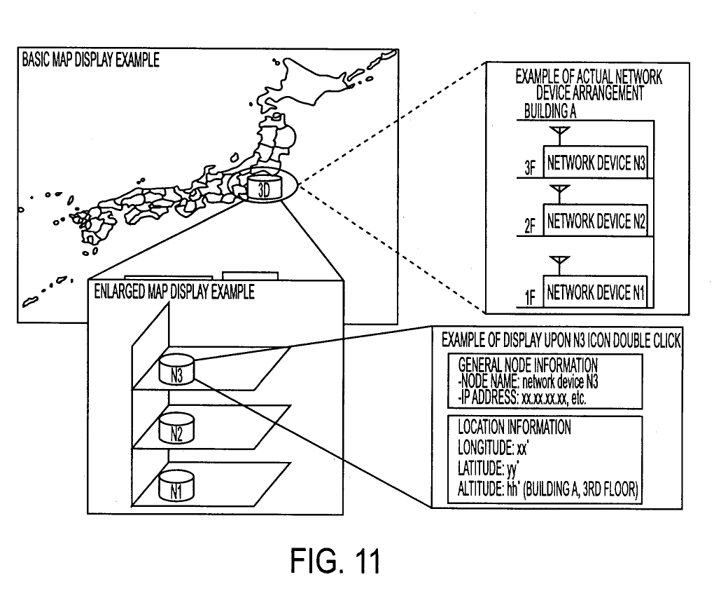

But in such an embodiment, if network devices N1, N2, N3 installed on different floors of building A shown in the upper right of FIG. 11 are installed all at the same latitude and longitude, it is impossible to distinguish the location information of each device. This problem is solved in this second embodiment.

That is, among GPS devices that receive GPS radio waves from GPS satellites, ones that have a function of being able to measure the altitude have been made into commercial products. In FIG. 11, a GPS device having such an altitude measurement function has been adopted, and one can identify in three dimensions the installation position of each communication device and determine their difference in altitude, thereby specifying the floor of the building on which each communication device is installed and located.

More specifically, it has the feature that it adopts a GPS device that can measure latitude, longitude, and elevation about sea level, and makes use of a map database that allows one to determine the altitude of the land surface at a specified latitude and longitude. Even without using a map database that allows one to determine the altitude of the land surface at a specified latitude and longitude, for the altitude of the land surface one may use the altitude information measured by a GPS device.

As has already been explained in embodiment 1, the essential difference with embodiment 2 is that location information acquisition device 110 of FIG. 4 can measure the altitude as well as the latitude and longitude. The latitude, longitude, and altitude can be output as location information, and the MIB generation unit generates this latitude, longitude, and altitude as location information MIB.

Also, SNMP agent 117 transmits to SNMP manager 201 in an SNMP message including the latitude, longitude, and altitude in the location information MIB.

In SNMP manager 201 and location information processing unit 202, it is different in that it handles an altitude that is added as location information, but otherwise essentially the same processing is done as in embodiment 1.

In map display unit 203, map processing unit 203 processes by the following procedure the location information passed from location information processing unit 202.

(1) Based on the longitude and location information included in the location information, map information of a suitable scale is read from the map database. The scale of the map information may be set according to an initial value or according to operator instructions. Also, the map information is read out so that the location information comes into the center of terminal 400, or the read-out map information may be edited.

(2) The altitude (elevation above sea level) information of the land surface that corresponds to the location information is acquired from the map database. Not all land surface altitude information is included in the map database, but the altitude of the desired location (latitude, longitude) may be determined by doing interpolation processing on the latitude, longitude, and altitude information between two or more points for which the altitude of the land surface has been set.

By a means such as this, one determines in meters the difference value between the altitude information obtained based on the longitude and latitude information included in the location information and the interpolation processing, and the altitude information included in the location information. Based on this difference value, one determines the altitude of the installation location of the relevant communication device.

By referring to a building floor and height-of-floor mapping table, one can determine on what floor this communication device is installed. The floor mapping table may be a simple table in which the height of each floor is associated with each floor, such as, first floor: 1 m, second floor: 4.5 m, . . . .

(3) Next, FIG. 11 shows an example in which the basic map display is displayed on a terminal screen based on the communication device's installation location information (latitude and longitude). The technology by which such a display is made has already been described in embodiment 1. But, as in the arrangement of actual network devices shown on the right side of FIG. 11, network devices N1, N2, N3 are installed on floors 1, 2, 3 of building A, respectively.

For example, if network device N2 (installed on the second floor of building A) detects an abnormality in its own device, it transmits to the SNMP manager of the monitoring device an SNMP message that includes the location information (longitude, latitude, altitude) in the trap message.

On this floor, as in the basic map display example of FIG. 11, network device N3 is displayed in a location in Tokyo.

But networks N1 and N3 are installed in the same installation location at the installation location of network device N3, and it is impossible to distinguish between them with just the latitude and longitude location information.

Thus a request (for example double click) for three-dimensional display is made to monitoring device 200. When this is done, the communication devices are displayed as shown in the “enlarged map display example” in FIG. 11. As a result of searching the network device control database based on the location information (latitude and longitude) transmitted from the communication device, as a result of searching the network device control database, network devices N1, N2, N3 can be extracted, and based on this information, a display can be made as in the “enlarged map display example” in FIG. 11. Moreover, for example by clicking on N3 (network device N3), information about the device information can be displayed, as in the “display example upon N3 icon double click”.

What is claimed is:

1. A location monitoring system having communication devices and a monitoring device which monitors said communication devices; said location monitoring system comprising
a communication device comprising:
a means for acquiring current location information;
a means for generating network control messages including the acquired location information; and
a means for transmitting the generated network control messages to said monitoring device; and
said monitoring device comprising:
a means for extracting said location information from received network control messages, and
a means for maping said location information of said communication devices onto map information and displays it on a terminal screen.

2. The location monitoring system of claim 1, wherein said monitoring device further includes
a means for extracting said location information from received network control messages, and
a means for mapping onto map information said location information of said communication device and information that abstracts network control messages other than said map information, and displays it on said terminal screen.

3. The location monitoring system of claim 1 wherein, said location information is acquired from a GPS device.

4. The location monitoring system of claim 1, wherein said location information is acquired from an output from portable terminals.

5. The location monitoring system of claim 1, wherein said network control messages are SNMP messages.

6. The location monitoring system of claim 5, wherein said SNMP messages include GetRequest, GetNextRequest, or Trap.

7. The location monitoring system of claim 1, wherein said communication device is a router.

8. The location monitoring system of claim 4, wherein said GPS device or portable terminal is installed where location information electromagnetic waves can be received, and said location information is transmitted to said communication device via a circuit.

9. The location monitoring system of claim 1, wherein said location information is location information that is output from portable terminals.

10. A location monitoring system having communication devices and a monitoring device which monitors said communication devices, said location monitoring system comprising:
a communication device including
a means for acquiring the latitude, longitude, and altitude as current location information,
a means for generating network control messages including the acquired current location information, and
a means for transmitting the generated network control messages to said monitoring device; and
said monitoring device including
a means for extracting said location information from received network control messages and
a means for mapping said location information of said communication devices onto map information and displays it on a terminal screen, and also displays information concerning said altitude.

11. In a communication device of a location monitoring system that has communication devices and a monitoring device that monitors said communication devices, and has a means that extracts location information from network control messages received from said communication devices, and maps it onto map information based on said location information and displays it on a terminal screen,
a communication device in a location monitoring system, said communication device includes:
a means for acquiring current location information,
a means fort generating network control messages including the acquired current location information, and
a means for transmitting the generated network control messages to a network manager.

12 In a monitoring device of a monitoring system that has communication devices and a monitoring device that monitors said communication devices, and a communication device has a unit that acquires current location information, generates network control messages including the acquired current location information, and transmits the generated network control messages to a network manager, said monitoring device comprising:
a management unit that extracts said location information from received network control messages; and
a mapping unit that maps said extracted location information of said communication devices onto map information and displays it on a terminal screen.

13. A monitoring device of a monitoring system that has communication devices and said monitoring device monitors said communication devices, and a communication device has a unit that acquires the latitude, longitude, and altitude as current location information, a unit that generates network control messages including the acquired current location information, and a unit that transmits the generated network control messages to said monitoring device, said monitoring device comprising:
a means that extracts said location information from received network control messages; and
a means that maps said location information of said communication devices onto map information and displays it on a terminal screen, and also displays information concerning said altitude.

14. A location display method for installed communication devices, said method comprising the steps of:
acquiring current location information of a communication device;
generating, by said communication device, a network control message including said current location information;
transmitting said generated network control message to a monitoring device;
extracting, by said monitoring device, said current location information from said received network control message; and
mapping said current location information of said communication device onto map information and displaying it on a terminal screen.
